(19) United States
(12) Patent Application Publication
(10) Pub. No.: US 2010/0280755 A1
(43) Pub. Date: Nov. 4, 2010

(54) METHOD, APPARATUS, AND SYSTEM FOR RAPID ASSESSMENT

(76) Inventors: Douglas J. Pillsbury, Suffolk, VA (US); Edward C. Goodwin, Edenton, NC (US)

Correspondence Address: DICKSTEIN SHAPIRO LLP, 1825 EYE STREET NW, Washington, DC, 20006-5403, US

(21) Appl. No.: 12/773,442

(22) Filed: May 4, 2010

Related U.S. Application Data
(60) Provisional application No. 61/175,167, filed on May 4, 2009.

(51) Int. Cl. G06F 19/00; G06Q 99/00

(52) U.S. Cl. 702/2; 702/19; 705/1.1

(57) ABSTRACT

Systems and devices for assessment of an impact by an event on an environment are disclosed. Processes for automated impact assessment are also disclosed. An impact assessment can be performed in computer-generated environments which include data regarding the environment impacted and data regarding the event impacting the environment. Environment data may be represented as a geospatial layer.

This application claims the benefit of U.S. Provisional Application Ser. No. 61/175,167, filed May 4, 2009, the entire disclosure of which is incorporated by reference herein

### FIELD OF THE INVENTION

Described embodiments relate to geographic information systems, including real-time, simulated, or predictive assessment of an impact of dynamic events.

### BACKGROUND OF THE INVENTION

The responsibility for predicting, preparing for, responding to, and analyzing dynamic and potentially critical events typically lies with emergency and recovery personnel including both “first responders” and national and international groups. Such events may include crises—weather events such as hurricanes, tsunamis, flooding, and rain, seismic events such as earthquakes, explosions, and volcanic eruptions, or other natural and non-natural events such as widespread fires and chemical or biological releases—or less critical events such as weather patterns or natural erosion. First responders may include local civic authorities, who are often the first to arrive on scene. National and international groups may include state national guards and governmental or semi-governmental organizations. Despite the best of intentions on the part of these personnel, grave deficiencies exist in their ability to create and exercise useful courses of action.

The ability to assess, in real-time, such events' potential impact on existing infrastructure, geography, and entities allows for efficient and safe allocation of people and resources when responding to an event. Further, the ability to predict or simulate the effects of such an event allows for responders to better prepare before an event actually occurs, or before all information is available.

### SUMMARY OF THE INVENTION

Geospatially-correct computer-generated environments can be used to perform training, planning, experimentation, response and recovery to an event. These environments model “real world” or simulated geographic areas, and may include environment-specific features, such as individualized details regarding the particular type of environment. These computer-generated environments are composed of geospatial layers of data, which can be stored in a database, other static repositories, or dynamically-retrievable locations, such as interne or satellite services. The geospatial layer of data may represent the geographic location, surface area, or volume (i.e., in polygon format), as well as characteristics of the represented geographic area.

While the need for information from a prediction, simulation, or assessment of an event is often time-sensitive, accurate assessments typically require on-location evaluation and collection of information by trained individuals, and cannot be output in useful form in real-time. Accordingly, there is a need and desire for processes and systems providing real-time, simulated, or predictive assessment of a potential impact of a dynamic event. Further, there is a need and desire for processes and systems capable of providing these assessments in as fast of a manner as possible. Furthermore, there is a need and desire for first responders and people other than those trained in geographic information systems to be able to obtain such assessments on the fly—both when deployed in the field and at a command center.

### BRIEF DESCRIPTION OF THE DRAWINGS

FIG. 1 shows a diagram of a system for receiving and assessing information regarding the impact of an event.

FIG. 2 shows a flow chart of a process for assessing an impact of an event.

FIG. 3 shows a flow chart of a rapid impact assessment of a weather event.

FIG. 4 shows a flow chart of a rapid impact assessment of a chemical or biological event.

FIG. 5 shows a flow chart of a rapid impact assessment of a seismic event.

### DETAILED DESCRIPTION

Embodiments described herein include systems and processes capable of providing real-time, simulated, or predictive assessment of a potential or real impact of an event. The assessment may be automated to allow for fast, efficient and user-friendly application, even by individuals not trained in geographic information systems technology.

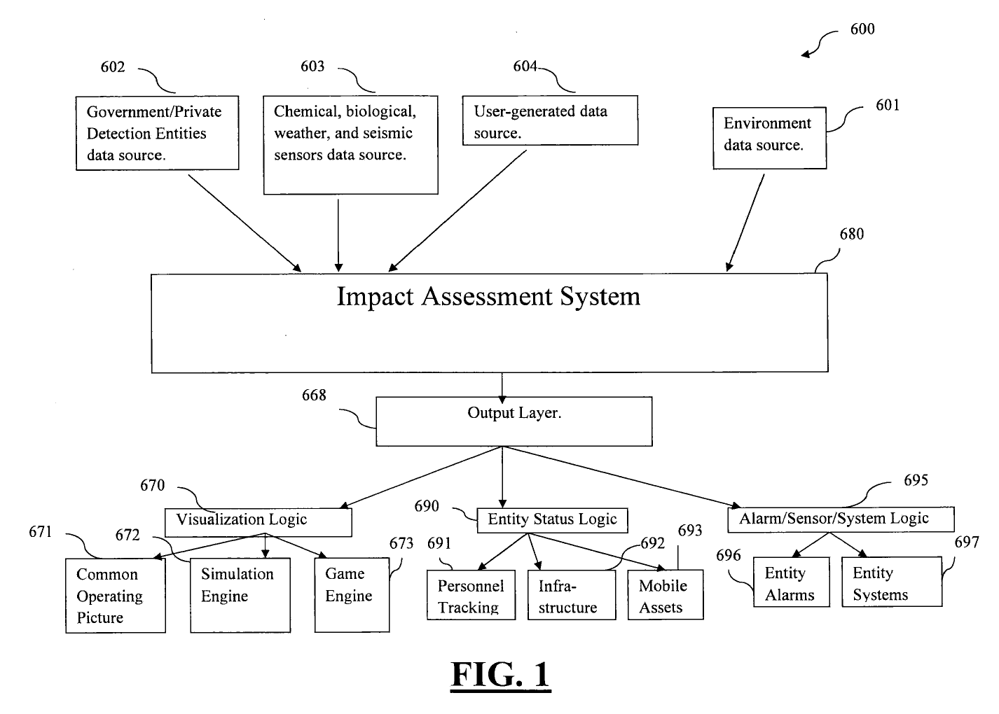

FIG. 1 shows a diagram of a system 600 for receiving and assessing the impact of an event on affected environments, and outputting information detailing the impacted environments for various purposes. System 600 includes impact assessment system 680, which may receive event data representing an event such as weather, flooding, hurricanes, biological or chemical releases, blasts, or earthquakes from one or more entities. For example, event data may be received from government or private event detection data sources 602, or from chemical, biological, weather, and seismic sensing data sources 603. User-generated event data may also be generated and input to system 600 by a user-generated data source 604.

Impact assessment system 680 also receives environment data from an environment data source 601, representing, for example, geographic or infrastructure environments, as described below. Environment data source 601 can be, for example, a database, other static repositories, or dynamically-retrievable locations, such as internet or satellite services.

The environment data is considered static data because it represents existing environments such as terrain, buildings, roads, or other geography and infrastructure. Environment data may be developed and stored using GIS, PostGIS, SQL, or other known development packages.

Environment data can represent, for example, traditional natural and physical terrain features of landscape, such as elevations, rivers, lakes, oceans, seas, flood data, or geological hazards. Environment data can also represent various human-derived mapping abstractions, such as geographic boundaries (i.e., borders). Environment data can also represent various critical infrastructures, including, for example: transportation, chemical, banking and finance, commercial, energy (i.e., electrical power plants, power grids, substations, power lines, natural gas), dams, public health/healthcare, emergency services such as fire stations, hospitals, law enforcement, shelters (i.e., Red Cross locations), and emergency evacuation routes, defense industrial base, nuclear, agriculture, postal and shipping, monuments and icons, government facilities, water systems, information technology systems, or communication systems. Environment data can also represent streets, interstates, major and minor highways, bridges and tunnels, commercial ports, train stations, transit lines, or heliports. Environment data can also represent building footprints or buildings themselves. Environment data may also represent schools, large venues, day care facilities, convalescent care, cemeteries, or funeral homes. Finally, environment data may also represent people of interest, such as government leaders or law enforcement personnel.

The event data 602, 603, 604 is considered dynamic data because it represents the event causing an impact on the environment represented by the environment data. Event data 602, 603, 604 can represent, for example: natural events, such as weather, earthquakes, fire, or flood, plumes of biological or chemical releases, blasts and explosions, political, military, economic, social, infrastructure, and information systems (referred to as “PMESII”), various demographical elements, and various intelligence reports mapped according to socio-cultural analyses. For example, chemical and biological plume information can be captured by CBRNE (chemical, biological, radiological, nuclear, and high-yield explosives) sensors, which send the information to a government or commercial entity such as JWARN (Joint Warning And Reporting Network), which in turns sends information to a JEM (Joint Event Model) program, which generates plume information. Chemical and biological plume information may also be received from entities such as HPAC (Hazard Prediction and Assessment Capabilities) and ALOHA systems. Flood information can be received by HAZUS (Hazards US, a GIS-based natural hazard loss estimation software package) or SLOSH (Sea, Lake, and Overland Surge from Hurricanes) systems. Blast or impact information can be received from CATS (an electronic design automation software) systems. Weather information can be received via radar or WIND systems, or an environmental impact report (IR/eIR). Biological information can be received from STEM (Spatiotemporal Epidemiological Modeler) software systems. Socio-cultural modeling information, for example, information related to likely residences of sex-offenders, may be generated by and retrieved from government or private entities and studies, such as watchdog groups. Earthquake information can be received in the form of a “shakemap,” a near-real-time map of ground motion and shaking intensity following significant earthquakes that is generated by the U.S. Geological Survey Earthquake Hazards Program in conjunction with regional seismic network operators. A video or audio device can also be a sensor for providing event data. Data provided by sensors may be transmitted over a variety of networks such as, for example, the Internet, wide area networks, global area networks, closed/private networks; local area networks, metropolitan area networks, wireless networks, cellular networks, or satellite networks. The transmitted data can be received by a computing apparatus to perform an impact assessment.

Both the environment and event layers designate the particular geographic location they represent, for example in the form of a polygon. Thus, for example, a footprint of a building, borders of a community, the dispersement of a plume of chemicals, or the circumference of a hurricane all are represented in respective environmental or event layers as polygons. The intersection points of these polygons, as discussed below, allows for the automated assessment of the impact caused by the event on the environment.

A user can select the desired event data from sources 602, 603, 604, and the desired environment data from one or more environment data sources 601 to be assessed by system 600. The selected environment and event data are retrieved by impact assessment system 680. Environment and event data can be received by impact assessment system 680 by, for example, by a data bus. The environment data representing the affected environment to be analyzed is either received as, or converted by impact assessment system 680 to, a geospatial layer, with each layer representing a part of the environment, for example, a piece of infrastructure. The environment layer is referred to as an “affected” layer, because it represents the environment which the event's impact will affect. Multiple affected layers can be input to impact assessment system 680 for assessment. The event data representing the event to impact the environment data is also either received as, or converted by impact assessment system 680 to, a layer, referred to as an “event” layer. An event layer can represent, for example, a flood, a chemical release, or a seismic event, or any other event to be assessed, as described above.

Each event layer and affected layer can be represented as a matrix, including rows and columns of data. For example, each row of a matrix of an event or affected layer may represent a geometric point in the environment or event being represented by that layer. Further, in addition to data representing its geographic location, each environment layer can contain data related to multiple features of the represented environment, such as the type of terrain or its height above sea-level. Furthermore, each event layer can contain data related to features of each point of the event, such as the depth of a point in a flood, the intensity of a point of a seismic event, or the contamination level of a point of a chemical emission plume.

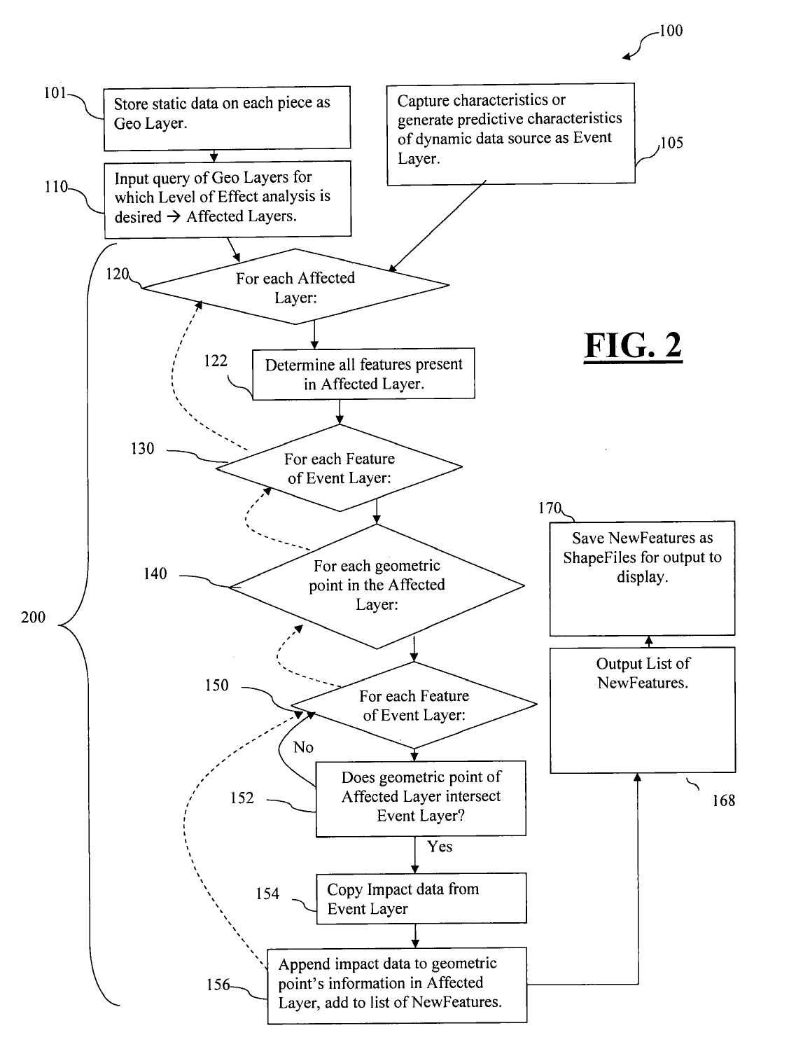

Impact assessment system 680 assesses the impact of one or more event layers from event data sources 602, 603, 604 on the environment data received from environment data source 601, according to an impact assessment process 200 (FIG. 2) described further below. The event data and environment data may be stored in a storage device; a storage device can be, for example, a hard disk drive, flash memory, an optical disk, or RAM. The impact assessment system 680 may be implemented with a computer processor configured to perform the impact assessment process, a computer or other device configured to access and perform the impact assessment process from a computer-readable medium or web-based proxy, or by other known means. Impact assessment system 680 may be implemented on a dedicated processor, or by a computer or other device configured to read a storage medium containing the instructions for the impact assessment process. For example, the impact assessment process 200 described below (FIG. 2) may be implemented by storing instructions on a computer readable storage medium using software platforms such as PostGIS, SQL, PostgreSQL, or other known platforms.

Impact assessment system 680 provides automated generation of predictive, simulated, or real-time assessment of the impact of an event, as described further below. Receiving impact information from sensors, or predicting the impact, allows for analysis without requiring on-location evaluation and collection of information by trained individuals. The resulting assessment can be output in useful form in real-time or near real-time. Furthermore, because impact assessment system 680 provides an automated and flexible system that can output a common operating picture to multiple entities, responders and people other than those trained in geographic information systems are able to both generate and obtain assessments on the fly—both when deployed in the field and at a command center.

The resulting data layer 668 can be output to one or more logic units for various purposes, including, for example: visualization logic 670 for use in Common Operating Picture (COP), a simulation engine 672, or a game engine 673; entity status logic 690 for purposes of directing and assessing personnel 691, infrastructure 692, or mobile assets 693; or alarm/sensor/system logic 695, for changing an affected entity's alarms 696 or modifying operation of an entity's systems 697.

The assessment operation performed by impact assessment system 680 is shown in detail in FIG. 2. FIG. 2 shows a flow chart of a process 100 for rapidly assessing an impact of an event on one or more selected environments.

In step 101, as discussed above, the static data is stored, for example, as a database, other static repositories stored in a storage medium, or dynamically-retrievable locations, such as internet or satellite services. As discussed above, this data may be stored as an environment layer, or may be converted to an environment layer through known processes upon receipt by impact assessment system 680 (FIG. 1).

In step 105, characteristics of an event are captured, received by other sources as described above, or generated by a user. This dynamic event data becomes the designated “event” layer. Each event layer may include multiple features, as discussed above. The event data may be stored in a storage medium such as a hard drive, optical disk, flash memory, RAM, etc.

In step 110, a user inputs a query of the environment layers for which impact assessment is desired. The queried environments become the designated “affected” layers. Each affected layer may include multiple features as well, as discussed above. The affected layers may be stored in a storage medium such as a hard drive, optical disk, flash memory, RAM, etc.

The selected event layer and affected layer(s) are input to an impact assessment process 200 that merges the data of the event layer and affected layer(s). Impact assessment process 200 is run for each affected layer, as indicated by step 120. For each affected layer, all features present in the affected layer are detected at step 122. A first feature of the event layer is then selected in step 130. At step 140, a geometric point (which may be represented by a row of the affected layer) is selected. At step 150, a first feature of the event layer is again selected. The selection processes can be accomplished by a selector, which may be, for example, the computer processor selecting which features and points will be assessed.

At step 152, for each feature in the event layer, impact assessment process 200 determines whether the selected geometric point of the affected layer (selected in step 140) intersects with the geometry of the event layer. An intersection can be detected, for example, using known objects and operations in publicly-available GIS software.

If the selected geometric point of the affected layer does intersect the event layer, the impact data for the feature (selected in step 150) is copied from the event layer at step 160, and merged with the data of the selected geometric point of the affected layer at step 154, for instance by adding a new column to the array of data representing the selected geometric point of the affected layer, and the merged data is added to a NewFeatures list. Steps 150, 152, 160, and 154 are then repeated for each feature of the event layer. Impact assessment process 200 then returns to step 140, and the next geometric point in the affected layer is selected, and steps 150, 152, 160, and 154 are again repeated. Once all geometric points in the affected layer have been processed in step 140, impact assessment process 200 returns to step 130 and runs for each other feature of the event layer. Once each feature of the event layer has been processed in step 130, impact assessment process 200 returns to step 120 and selects the next affected layer. Impact assessment process 200 continues until the impact of the event on each affected layer has been assessed.

Once all selected affected layers have been assessed in impact assessment process 200, the list of NewFeatures is output in step 168. The output list of NewFeatures can, for example, then be saved as a ShapeFile, for output to a display, as shown in step 170. It should be understood, however, that the output list of NewFeatures may be output to other entities for additional purposes, for example, those described above with regard to FIG. 1, and may also be saved back to the environment data source 601 (FIG. 1).

All or portions of process 100, including impact assessment process 200, can be automated to provide fast, efficient, and user-friendly impact assessment.

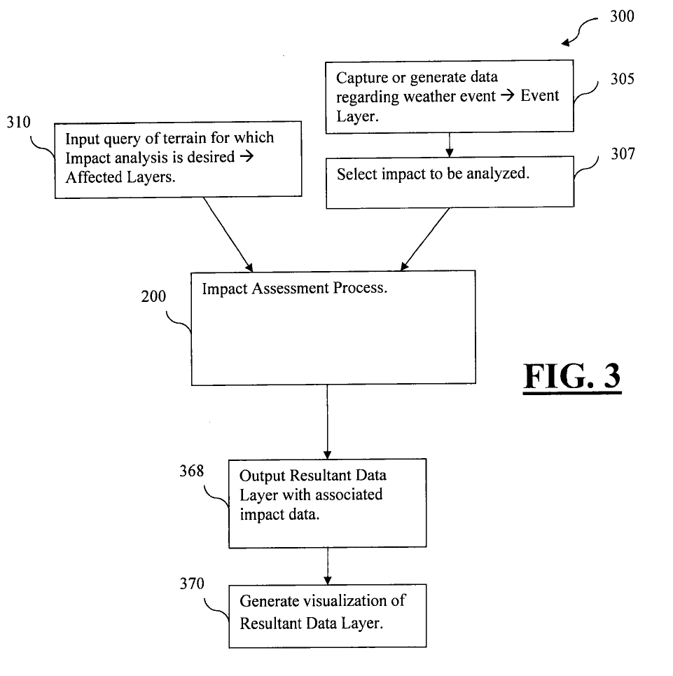

FIG. 3 shows a flow chart of one example of a rapid impact assessment 300, using the impact assessment process 200 described above with regard to FIG. 2. The rapid impact assessment 300 shown in FIG. 3 assesses the impact, such as flooding, of a weather event, such as a hurricane, on affected layers representing terrain. Rapid impact assessment 300 can be conducted in real-time or near real-time as an event is happening, or before an event happens (using simulated data).

At step 305, data regarding the weather event is captured or generated by a user. Data capture can be done in real-time by, for example, private or government weather tracking sources, or can be generated by a user. The weather event is stored as an event layer. The user can optionally select the impact to be assessed, such as flooding, at step 307. Alternatively, no specific impact is designated, and all impacts of the event layer are assessed.

At step 310, the user inputs a query for the environment(s) (such as terrain) for which impact assessment is desired. The data representing the queried environment(s) is retrieved from one or more environment data sources 601 (FIG. 1). The environment data is either received as an environment layer, or is converted to an environment layer by damage assessment system 680 (FIG. 1). The selected environment layers are designated as the affected layers.

The selected event and affected layers are then assessed using the impact assessment process 200 described above with regard to FIG. 2. The resultant data layer with associated impact data (i.e., the List of NewFeatures) is output at step 368, and may be used for multiple various uses, as described above. For example, as shown in step 370, the data may be output to visualization logic to generate a visualization showing first responders the flooding caused by a hurricane. A visualization of the impact would be outputted to a display device; a display device can be, for example, an LCD monitor, CRT monitor, plasma monitor, etc. This allows the Emergency Operations Center (EOC) looking at roads for evacuation, food services distribution, etc. to visualize how deep the flooding is along any given route. Likewise, emergency planners can see if a hospital, fire station, airport, etc. is flooded or available for use. Non-ambulatory persons in nursing homes, convalescent homes, psychiatric hospitals, etc. can be identified as potentially needing rescue due to inaccessibility or threat of rising flood waters. Mobile and/or dynamic assets such as buses, fuel services, EMS (emergency medical services) vehicles, can be positioned outside potential flooding hazard areas and positioned in areas where they will be needed. It should be understood, however, that numerous other uses for the output data layer are within the scope of the rapid damage assessment 300 shown in FIG. 3.

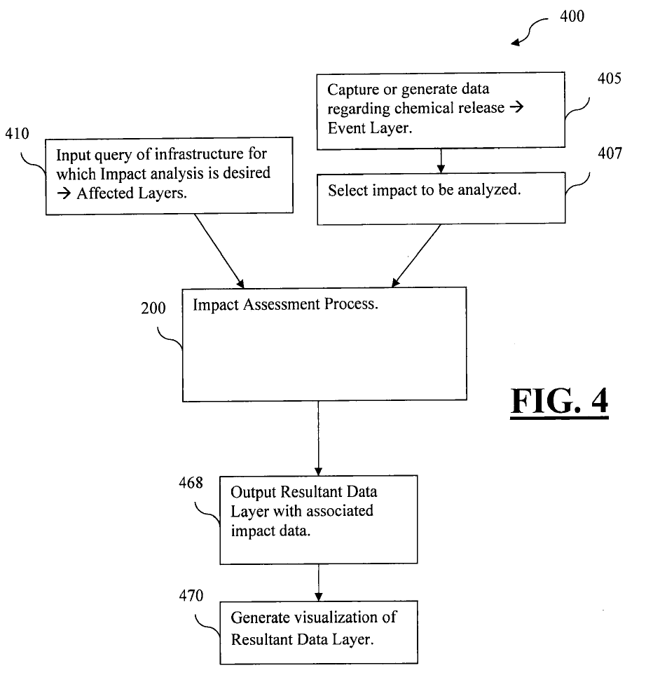

FIG. 4 shows a flow chart of another example of a process employing the rapid impact assessment process described above with regard to FIG. 2. The rapid impact assessment 400 shown in FIG. 4 assesses the impact, such as contamination levels, of a chemical or biological event, such as a chemical or biological release, on affected layers representing infrastructure, for example, buildings in a community. Rapid impact assessment 400 can be conducted in real-time or near real-time as an event as happening, or before an event happens (using simulated data).

At step 405, data regarding the chemical or biological event is captured or generated by a user. Data capture can be done in real-time by, for example, private or government sensors, or can be generated by a user. For example, when a commercial or government sensor detects a chemical release, software suites such as JEM (Joint Effect Model) or HPAC (Hazard Prediction and Assessment Capability) can receive detected information from one or more chemical or biological sensors and generate a hazard prediction plume, representing the area and contamination levels of the chemical release. The hazard prediction plume is stored as an event layer. The user can optionally select the impact to be assessed, such as contamination, at step 407. Alternatively, no specific impact is designated, and all impacts of the event layer are assessed.

At step 410, the user inputs a query for the environment(s) (such as infrastructure) for which impact assessment is desired. The data representing the queried environment(s) is retrieved from one or more environment data sources 601 (FIG. 1). The environment data is either received as an environment layer, or is converted to an environment layer by damage assessment system 680 (FIG. 1). The selected environment layers are designated as the affected layers.

The selected event and affected layers are then assessed using the impact assessment process 200 described above with regard to FIG. 2. The resultant data layer with associated impact data (i.e., the List of NewFeatures) is output at step 468, and may be used for multiple various uses, as described above. For example, as shown in step 470, the data may be output to visualization logic to generate a visualization, allowing a user to identify and display which infrastructure is contaminated and to what level of potential contamination. Further, as discussed above with regard to FIG. 1, the data can be output to entity status logic 690 or alarm status logic 695, for example, notifying the individual infrastructures identified in the hazard area and sending a message to automatically disengage air handling systems, isolate water distribution systems, prevent human transportation in and out of the hazard area, thereby minimizing human exposure and preventing the spread of the potential contaminant. It should be understood, however, that numerous other uses for the output data layer are within the scope of the rapid damage assessment 400 shown in FIG. 4.

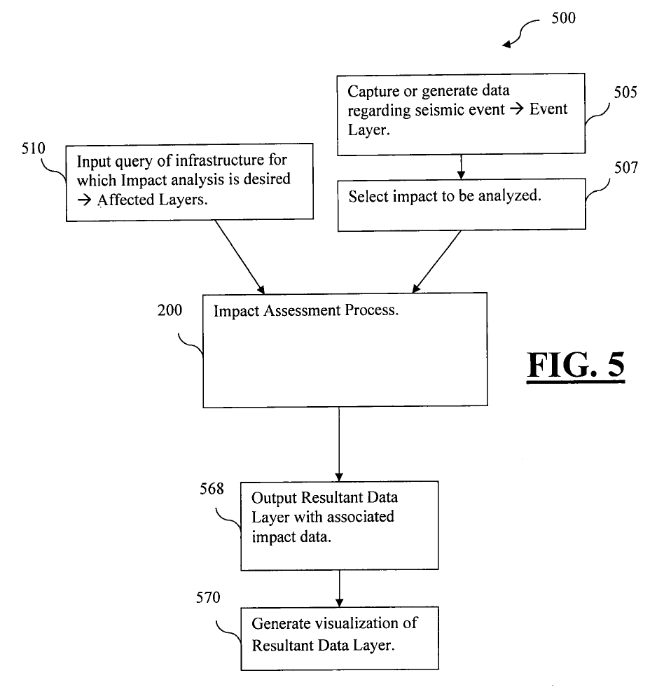

FIG. 5 shows a flow chart of another example of a process employing the rapid impact assessment process described above with regard to FIG. 2. The rapid impact assessment 500 shown in FIG. 5 assesses the impact, such as change in entity status, caused by a seismic event, such as an earthquake, on affected layers representing infrastructure, for example, a hospital. Rapid impact assessment 500 can be conducted in real-time or near real-time as an event as happening, or before an event happens (using simulated data).

At step 505, data regarding the seismic event is captured or generated by a user. Data capture can be done in real-time or near real-time by, for example, retrieving a “shakemap.” A shakemap is a near-real-time map of ground motion and shaking intensity following significant earthquakes that is generated by the U.S. Geological Survey Earthquake Hazards Program in conjunction with regional seismic network operators. The shakemap is stored as an event layer. The user can optionally select the impact to be assessed, such as the state of an affected entity, at step 507. Alternatively, no specific impact is designated, and all impacts of the event layer are assessed.

At step 510, the user inputs a query for the environment(s) (such as a hospital) for which impact assessment is desired. The data representing the queried environment(s) is retrieved from one or more environment data sources 601 (FIG. 1). The environment data is either received as an environment layer, or is converted to an environment layer by damage assessment system 680 (FIG. 1). The selected environment layers are designated as the affected layers.

The selected event and affected layers are then assessed using the impact assessment process 200 described above with regard to FIG. 2. The resultant data layer with associated impact data (i.e., the List of NewFeatures) is output at step 568, and may be used for multiple various uses, as described above. For example, as shown in step 570, the data may be output to visualization logic to generate a visualization, displaying the current state of the hospital (i.e., inoperable, on fire, structurally unsound, or destroyed). The visual state may be shown various types of display devices, such as computer monitors. It should be understood, however, that numerous other uses for the output data layer are within the scope of the rapid damage assessment 500 shown in FIG. 5.

Embodiments described herein provide automated generation of predictive, simulated, near real-time, or real-time assessment of the impact of an event, as described above. Receiving impact information from sensors, or predicting the impact, allows for analysis without requiring on-location evaluation and collection of information by trained individuals. The resulting assessment can be output in useful form in real-time or near real-time. Furthermore, because embodiments described above provide an automated an flexible system, responders and people other than those trained in geographic information systems are able to obtain assessments on the fly—both when deployed in the field and at a command center. In addition, embodiments described above allow training, experimentation, response, recovery, and planning to be performed in safe environments where the scenario (i.e., the impact of interest) does not have to occur to study and plan how first responders and others will respond and react to the event.

While various embodiments are described above, it should be understood that the scope of the disclosure is not so limited. For example, while various sources of event and environmental data are described above, numerous other sources exist, and their use in the impact assessment methods, systems, and apparatuses described above are within the scope of the present disclosure. Further, steps listed in the above-described processes and methods are not limited to the specific order in which they are numbered or described, unless necessary or specifically stated.

What is claimed is:

1. A method performed by a computer system for processing an impact assessment, comprising the steps of:
receiving at least one of a plurality of environment layers comprising at least one environment feature and at least one environment geometric point;
receiving at least one event layer comprising at least one event feature;
receiving a query designating at least one affected layer, selected from the at least one of the plurality of environment layers; and
performing an impact assessment for the at least one affected layer, the impact assessment comprising:
detecting all environment features present in the affected layer;
performing an impact assessment, further comprising the steps of:
selecting an event feature of the received event layer;
selecting an environment geometric point of the affected layer;
determining if the selected environment geometric point intersects with the selected event feature; and
merging the selected environment geometric point with the selected event feature when the environment geometric point intersects with the event feature.

2. The method of claim 1, wherein the determining step is repeated for all remaining event features.

3. The method of claim 2, wherein performing an impact assessment for the at least one affected layer further comprises performing the determining step for all remaining environment geometric points.

4. The method of claim 3, wherein performing an impact assessment for the at least one affected layer further comprises performing the selecting step for all remaining event features.

5. The method of claim 4, further comprising the steps of performing the impact assessment steps for all remaining designated affected layers.

6. The method of claim 1, further comprising the step of outputting the results of the impact assessment.

7. The method of claim 1, wherein the event layer corresponds to an event selected from a group consisting of natural events, chemical releases, biological releases, explosions, and socio-cultural events.

8. The method of claim 1, wherein the environment layer corresponds to an environment selected from a group consisting of natural terrain, geographic boundaries, infrastructure, buildings, and people.

9. The method of claim 1, wherein the environment layer is represented by at least one environment polygon and the event layer is represented by at least one event polygon.

10. A computer system for performing an impact assessment comprising:
a data bus for receiving at least one environment layer comprising at least one environment feature and at least one environment geometric point, at least one event layer comprising at least one event feature, and a query designating at least one affected layer, selected from the at least one environment layers;
a storage device for storing the at least one environment layer, the designated at least one affected layer, and the at least one event layer;
a processor for performing an impact assessment for the at least one affected layer by detecting all environment features present in the affected layer,
a selector for selecting an event feature of the event layer, selecting an environment geometric point of the affected layer, and reselecting the event feature of the event layer,
wherein the processor determines if the selected environment geometric point intersects with the event feature, and merges the selected environment geometric point with the event feature when the environment geometric point intersects with the event feature; and
a display device for outputting the result of the impact assessment.

11. The computer system of claim 10, wherein the processor determines the impact assessment for all remaining event features stored in the storage device.

12. The computer system of claim 11, wherein the processor determines the impact assessment for all remaining environment geometric points.

13. The computer system of claim 12, wherein the selector selects event features for all remaining event features.

14. The computer system of claim 13, wherein the processor performs the impact assessment for all remaining designated affected layers stored in the storage device.

15. The computer system of claim 10, wherein the display output is a visualization of the results of the impact assessment.

16. The computer system of claim 10, wherein the event layer corresponds to an event selected from a group consisting of natural events, chemical releases, biological releases, explosions, and socio-cultural events.

17. The computer system of claim 10, wherein the environment layer corresponds to an environment selected from a group consisting of natural terrain, geographic boundaries, infrastructure, buildings, and people.

18. The computer system of claim 10, wherein the environment layer is represented by at least one environment polygon and the event layer is represented by at least one event polygon.

19. A computing apparatus comprising:
a storage device for storing at least one environment layer and at least one event layer;
an input device for inputting at least one query designating at least one affected layer, selected from the at least one environment layers;
a processing device for merging the at least one affected layer and the at least one event layer when there is an intersection between the environmental layer and the event layer; and
a output device for outputting the results of the merger of the at least one affected layer and the at least one environmental layer.

20. The computing apparatus of claim 19, wherein the event layer corresponds to an event selected from a group consisting of natural events, chemical releases, biological releases, explosions, and socio-cultural events and the environment layer corresponds to an environment selected from a group consisting of natural terrain, geographic boundaries, infrastructure, buildings, and people.

21. The computing apparatus of claim 19, wherein the outputted result of the merger is selected from a group of output types consisting of visualization, entity stats logic, and alarm status logic.

22. A communications network comprising:
at least one sensor providing information corresponding to at least one event layer;
a computing network connected to the at least one sensor comprising:
a receiving portion for receiving information corresponding to the at least one event layer;
a storage device for storing at least one environment layer and the at least one event layer;
an input device for inputting at least one query designating at least one affected layer, selected from the at least one environment layers;
a processing device for merging the at least one affected layer and the at least one event layer when there is an intersection between the environmental layer and the event layer; and
an output device for outputting the results of the merger of the at least one affected layer and the at least one environmental layer.
